(19) United States
(12) Patent Application Publication
(10) Pub. No.: US 2024/0389104 A1
(43) Pub. Date: Nov. 21, 2024

(54) WIRELESS COMMUNICATOR METHOD FOR PUCCH REPETITIONS, APPARATUS, AND STORAGE MEDIUM

(71) Applicant: ZTE Corporation, Shenzhen (CN)

(72) Inventors: Wei GOU, Shenzhen (CN); Xianghui HAN, Shenzhen (CN); Xingguang WEI, Shenzhen (CN); Shuaihua KOU, Shenzhen (CN)

(73) Assignee: ZTE Corporation, Shenzhen, GD (CN)

(21) Appl. No.: 18/790,226

(22) Filed: Jul. 31, 2024

Related U.S. Application Data
(63) Continuation of application No. PCT/CN2022/109786, filed on Aug. 2, 2022.

(51) Int. Cl. H04W 72/21; H04L 5/14; H04W 56/00; H04W 72/0446; H04W 72/0453

(52) U.S. Cl. CPC H04W 72/21; H04L 5/14; H04W 56/0045; H04W 72/0446; H04W 72/0453

(57) ABSTRACT

A wireless communication method includes receiving a signaling, from a base station (BS), to indicate a user equipment (UE) to perform a PUCCH transmission with N PUCCH repetitions, N being an integer larger than 1; determining one or more slots for the PUCCH transmission; and transmitting the PUCCH repetitions in the one or more slots.

### TECHNICAL FIELD

This disclosure is generally related to PUCCH transmission, and more particularly to resource arrangement for PUCCH transmission.

### BACKGROUND

Wireless communication technologies are pivotal components of the increasingly interconnecting global communication networks. Wireless communications rely on accurately allocated time and frequency resources for transmitting and receiving wireless signals. PUCCH (Physical Uplink Control Channel) carries uplink control information from a user equipment (UE) to a base station (BS). The PUCCH repetition technique provides a better uplink coverage performance for UEs at the cell edge. However, allocation the resources for the PUCCH repetition scheme may have influence to the overall performance of uplink (UL) and downlink (DL) transmission.

### SUMMARY

This summary is a brief description of certain aspects of this disclosure. It is not intended to limit the scope of this disclosure.

According to one embodiment of this disclosure, a wireless communication is provided. The method includes receiving a signaling, from a base station (BS), to indicate a user equipment (UE) to perform a PUCCH transmission with N PUCCH repetitions using a PUCCH resource, N being an integer larger than 1; determining one or more slots for the PUCCH transmission, wherein the one or more slots include a plurality of consecutive symbols, a number of the consecutive symbols being equal to or larger than a number of symbols configured for the PUCCH resource, wherein the plurality of consecutive symbols include a first symbol being the same as a start symbol configured for the PUCCH resource, wherein the first symbol is at least one of:
a downlink (DL) symbol configured for an uplink (UL) subband;
a flexible (F) symbol configured for a UL subband;
a symbol configured for a UL subband;
a symbol configured for a subband full-duplex operation;
a symbol valid for UL transmission in the UL subband;
a UL symbol; or
a F symbol, wherein the consecutive symbols starting from the first symbol, the consecutive symbols being:
all DL symbols configured for the UL subband;
all symbols configured for the subband full-duplex operation;
all UL symbols;
all valid symbols the PUCCH resource;
partially symbols of the UL subband and partially UL symbols;
partially symbols for the UL subband and partially F symbols; or
partially symbols for the UL subband, partially UL symbols, and partially F symbols; and transmitting the PUCCH repetitions in the one or more slots.

Still another embodiment of this disclosure provides another wireless communication method, including: transmitting a signaling, from a base station (BS), to indicate a user equipment (UE) to perform a PUCCH transmission with N PUCCH repetitions using a PUCCH resource, N being an integer larger than 1; determining one or more slots for the PUCCH transmission, wherein the one or more slots include a plurality of consecutive symbols, a number of the consecutive symbols being equal to or larger than a number of symbols configured for the PUCCH resource, wherein the consecutive symbols include a first symbol being the same as a start symbol configured for the PUCCH transmission, wherein the first symbol is at least one of:
a downlink (DL) symbol configured for an uplink (UL) subband;
a flexible (F) symbol configured for a UL subband;
a symbol configured for a UL subband;
a symbol configured for a subband full-duplex operation;
a symbol valid for UL transmission in the UL subband;
a UL symbol; or
a F symbol; wherein the consecutive symbols starting from the first symbol, the consecutive symbols being:
all DL symbols configured for the UL subband;
all symbols configured for the subband full-duplex operation;
all UL symbols;
all valid symbols the PUCCH resource;
partially symbols of the UL subband and partially UL symbols;
partially symbols for the UL subband and partially F symbols; or
partially symbols for the UL subband, partially UL symbols, and partially F symbols; and receiving the PUCCH repetitions in the one or more slots.

Still another embodiment of this disclosure provides a wireless communication apparatus, including a memory storing one or more programs and a processor electrically coupled to the memory and configured to execute the one or more programs to perform any method or step or their combination in this disclosure.

Still another embodiment of this disclosure provides non-transitory computer-readable storage medium, storing one or more programs, the one or more program being configured to, when executed by a processor, cause to perform any method or step or their combination in this disclosure.

The above and other aspects and their implementations are described in greater detail in the drawings, the descriptions, and the claims.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIG. 1 shows an exemplary wireless communication system, which can implement the methods and/or steps in this disclosure;

FIG. 2 illustrates a signal transmission diagram of PUCCH repetitions;

FIG. 3 illustrates another signal transmission diagram of PUCCH repetitions;

FIG. 4 illustrates another signal transmission diagram of PUCCH repetitions;

FIG. 5 illustrates another signal transmission diagram of PUCCH repetitions;

FIG. 6 illustrates another signal transmission diagram of PUCCH repetitions;

FIG. 7A illustrates another signal transmission diagram with a plurality of slot;

FIG. 7B illustrates another signal transmission diagram with Timing Advance; and

FIG. 8 illustrates another signal transmission diagram of PUCCH repetitions.

### DETAILED DESCRIPTION

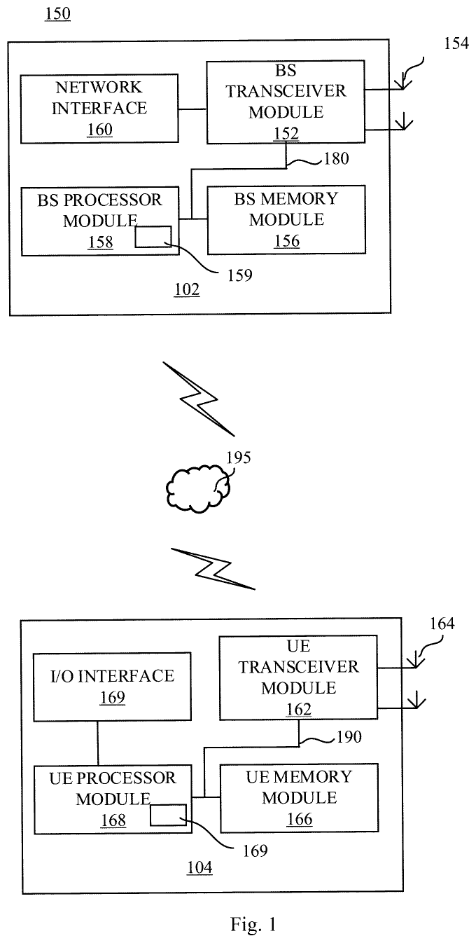

FIG. 1 illustrates a block diagram of an exemplary wireless communication system 150, in accordance with some embodiments of this disclosure. The system 150 may perform the various methods/steps disclose below. The system 150 may include components and elements configured to support operating features that need not be described in detail herein.

The system 150 may include a base station (BS) 102 and a user equipment (UE) 104. The BS 102 includes a BS transceiver or transceiver module 152, a BS antenna system 154, a BS memory or memory module 156, a BS processor or processor module 158, and a network interface 160. The components of BS 102 may be electrically coupled and in communication with one another as necessary via a data communication bus 180. Likewise, the UE 104 includes a UE transceiver or transceiver module 162, a UE antenna system 164, a UE memory or memory module 166, a UE processor or processor module 168, and an I/O interface 169. The components of the UE 104 may be electrically coupled and in communication with one another as necessary via a date communication bus 190. The BS 102 communicates with the UE 104 via a communication channel 192, which can be any wireless channel or other medium known in the art suitable for transmission of data as described herein.

As would be understood by persons of ordinary skill in the art, the system 150 may further include any number of modules other than the modules shown in FIG. 1. Those having ordinary skill in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from a transmitting antenna of the UE 104 (referred to singular form for convenience, but can include multiple antennae) to a receiving antenna of the BS 102 (referred to singular form for convenience, but can include multiple antennae) is known as an uplink (UL) transmission, and a wireless transmission from a transmitting antenna of the BS 102 to a receiving antenna of the UE 104 is known as a downlink (DL) transmission. In accordance with some embodiments, the UE transceiver 162 may be referred to herein as an “uplink” transceiver 162 that includes a RF transmitter and receiver circuitry that are each coupled to the UE antenna 164. A duplex switch (not shown) may alternatively couple the uplink transmitter or receiver to the uplink antenna in time duplex fashion. Similarly, in accordance with some embodiments, the BS transceiver 152 may be referred to herein as a “downlink” transceiver 152 that includes RF transmitter and receiver circuitry that are each coupled to the antenna array 154. A downlink duplex switch may alternatively couple the downlink transmitter or receiver to the downlink antenna array 154 in time duplex fashion. The operations of the two transceivers 152 and 162 are coordinated in time such that the uplink receiver is coupled to the uplink UE antenna 164 for reception of transmissions over the wireless communication channel 192 at the same time that the downlink transmitter is coupled to the downlink antenna array 154. There may be close synchronization timing with only a minimal guard time between changes in duplex direction. The UE transceiver 162 communicates through the UE antenna 164 with the BS 102 via the wireless communication channel 192. The BS transceiver 152 communicates through the BS antenna 154 of a BS (e.g., the first BS 102) with the other BS (e.g., the second BS 102-2) via a wireless communication channel 192. The wireless communication channel 196 can be any wireless channel or other medium known in the art suitable for direct communication between BS s.

The UE transceiver 162 and the BS transceiver 152 are configured to communicate via the wireless data communication channel 192, and cooperate with a suitably configured RF antenna arrangement 154/164 that can support a particular wireless communication protocol and modulation scheme. In some exemplary embodiments, the UE transceiver 162 and the BS transceiver 152 are configured to support industry standards such as the Long-Term Evolution (LTE) and 5G standards (e.g., NR), and the like. It is understood, however, that the invention is not necessarily limited in application to a particular standard and associated protocols. Rather, the UE transceiver 162 and the BS transceiver 152 may be configured to support alternative, or additional, wireless data communication protocols, including future standards or variations thereof.

The processor modules 158 and 168 may be implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 158 and 168, respectively, or in any practical combination thereof. The memory modules 156 and 166 may be realized as RAM memory, flash memory, ROM memory, EPROM memory, EEPROM memory, registers, a hard disk, a removable disk, a CD-ROM, or any other form of storage medium known in the art. In this regard, the memory modules 156 and 166 may be coupled to the processor modules 158 and 168, respectively, such that the processors modules 158 and 168 can read information from, and write information to, memory modules 156 and 166, respectively. The memory modules 156 and 166 may also be integrated into their respective processor modules 158 and 168. In some embodiments, the memory modules 156 and 166 may each include a cache memory for storing temporary variables or other intermediate information during execution of instructions to be executed by processor modules 158 and 168, respectively. The memory modules 156 and 166 may also each include non-volatile memory for storing instructions to be executed by the processor modules 158 and 168, respectively.

The network interface 160 generally represents the hardware, software, firmware, processing logic, and/or other components of the base station 102 that enable bi-directional communication between BS transceiver 152 and other network components and communication nodes configured to communication with the BS 102. For example, network interface 160 may be configured to support internet or WiMAX traffic. In a typical deployment, without limitation, network interface 160 provides an 802.3 Ethernet interface such that BS transceiver 152 can communicate with a conventional Ethernet based computer network. In this manner, the network interface 160 may include a physical interface for connection to the computer network (e.g., Mobile Switching Center (MSC)) or one or more core network 195 for mobile communications. The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 160 could allow the BS 102 to communicate with other BSs or a CN over a wired or wireless connection.

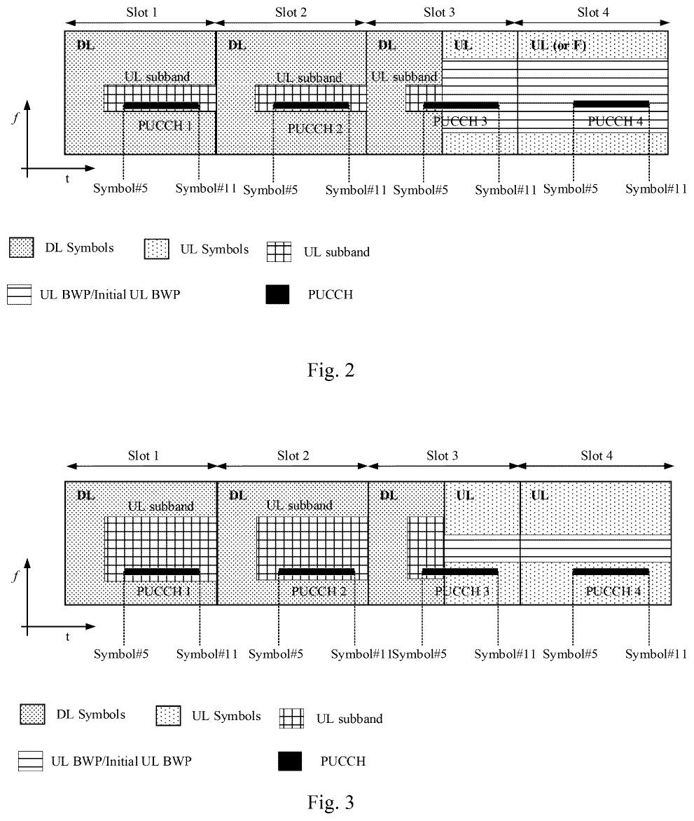

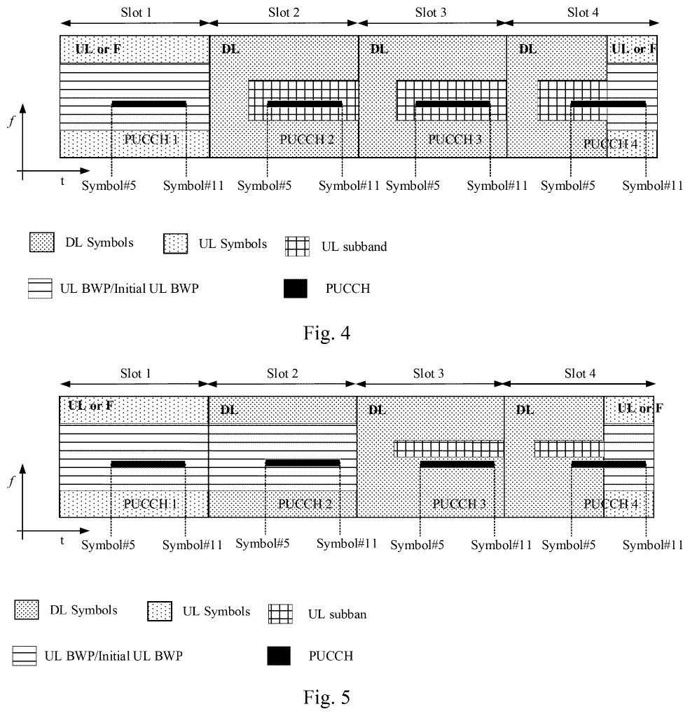

According to the PUCCH repetition scheme, the BS may configure the UE to transmit PUCCH repetitively. As shown in FIG. 2, the PUCCH (such as PUCCH 1 indicated as black rectangular) can be transmitted in a UL subband in a downlink (DL) slot, which is a slot having DL symbols. The horizontal axis of the transmission diagram in FIG. 2 stands for the time axis, and the vertical axis of the transmission diagram in FIG. 2 stands for the frequency axis. At a specific time, the channel includes multiple carriers of different carrier frequencies. The UL subband is a carved out of the DL slot at a specific frequency spectrum, which can be used to perform the uplink (UL) transmission. Each slot may include fourteen consecutive symbols, numbered from 0 to 13. In the example of FIG. 2, the PUCCH is transmitted with a UL subband between symbol 5 and symbol 11. After the first PUCCH, PUCCH 1, is transmitted, the UE may determine a proper slot to transmitted the remaining PUCCH repetitions. On the other hand, as shown in FIG. 4, the first PUCCH can be transmitted in a UL slot, includes UL symbols, or a flexible slot. The other transmission diagrams in this disclosure are annotated in the similar manners.

According to one embodiment, this disclosure provides a wireless transmission method to assign the resource of the PUCCH repetition. The method includes:

S110: receiving a signaling, from a base station (BS), to indicate a user equipment (UE) to perform a PUCCH transmission with N PUCCH repetitions, N being an integer larger than 1;

S120: determining one or more slots for the PUCCH transmission, wherein the one or more slots include a plurality of consecutive symbols, a number of the consecutive symbols being equal to or larger than a number of symbols configured for the PUCCH resource, wherein the plurality of consecutive symbols include a first symbol being the same as a start symbol configured for the PUCCH resource, wherein the first symbol is at least one of:
a downlink (DL) symbol configured for an uplink (UL) subband;
a flexible (F) symbol configured for a UL subband;
a symbol configured for a UL subband;
a symbol configured for a subband full-duplex operation;
a symbol valid for UL transmission in the UL subband;
a UL symbol; or
a F symbol, wherein the consecutive symbols starting from the first symbol, the consecutive symbols being:
all DL symbols configured for the UL subband;
all symbols configured for the subband full-duplex operation;
all UL symbols;
all valid symbols the PUCCH resource;
partially symbols of the UL subband and partially UL symbols;
partially symbols for the UL subband and partially F symbols; or
partially symbols for the UL subband, partially UL symbols, and partially F symbols; and
S130: transmitting the PUCCH repetitions in the one or more slots.

In S110, the BS can transmit a signaling and the UE can receive the signaling transmitted by the BS. The signaling can configure the UE, such that the UE may transmit N PUCCH repetitions. N is an integer larger than 1. For example, if N is 4, the UE may transmit three remaining PUCCH repetition after the first PUCCH, PUCCH 1, is transmitted as shown in FIG. 2 and FIG. 3.

Corresponding, this disclosure provides a wireless transmission method performed by a BS. The method includes, transmitting a signaling, from a base station (BS), to indicate a user equipment (UE) to perform a PUCCH transmission with N PUCCH repetitions, N being an integer larger than 1; determining one or more slots for the PUCCH transmission, wherein the one or more slots include a plurality of consecutive symbols, a number of the consecutive symbols being equal to or larger than a number of symbols configured for the PUCCH resource, wherein the plurality of consecutive symbols include a first symbol being the same as a start symbol configured for the PUCCH resource, wherein the first symbol is at least one of:
a downlink (DL) symbol configured for an uplink (UL) subband;
a flexible (F) symbol configured for a UL subband;
a symbol configured for a UL subband;
a symbol configured for a subband full-duplex operation;
a symbol valid for UL transmission in the UL subband;
a UL symbol; or a
F symbol, wherein the consecutive symbols starting from the first symbol, the consecutive symbols being:
all DL symbols configured for the UL subband;
all symbols configured for the subband full-duplex operation;
all UL symbols;
all valid symbols the PUCCH resource;
partially symbols of the UL subband and partially UL symbols;
partially symbols for the UL subband and partially F symbols; or
partially symbols for the UL subband, partially UL symbols, and partially F symbols; and
receiving the PUCCH repetitions in the one or more slots.

In S110, the UE receive a signaling transmitted by the BS. The signaling is used to indicate the UE to perform a PUCCH transmission with N PUCCH repetitions, N being an integer larger than 1. For example, the N can be four as shown in the transmission diagrams FIGS. 2-6.

To transmit the N PUCCH repetitions, the UE may determine one or more slots for the PUCCH transmission. Each of the one or more slots may include a plurality of consecutive symbols starting from the first symbol. To serve as the slots to be used for the PUCCH repetitions, the number of the consecutive symbols is equal to or larger than a number of symbols configured for the PUCCH transmission. For example, the number of the consecutive symbols for the remining N−1 repetitions following the first repetition is equal to or larger than the symbols of the first repetition.

For example, as shown in FIG. 2, the PUCCH 1 in Slot 1 includes 7 symbols, symbol 5 to symbol 11. The remaining N−1 repetitions may have the same number (7) of the symbols at the same corresponding time domain of the following slots. Therefore, when UE determines one or more slot for the remaining repetitions, the UE may need to find a slot having sufficient consecutive symbols that can allocate the required number of symbols.

Additionally, the consecutive symbols includes a first symbol being the same as a start symbol configured for the PUCCH transmission, such that the PUCCH repetitions can start a same corresponding time domain location. For example, as shown in FIG. 2, PUCCH 1 includes 7 symbols, starting from symbol 5, where symbol 5 can be a start symbol configured for the PUCCH transmission. When the UE determines the slot for the PUCCH repetitions, the UE finds a slot having consecutive symbols including the same first symbols, symbol number 5 in the following slots, 2, 3, etc., such that the PUCCH repetitions can start at the same symbol numbering.

With respect to the attribute of the first symbols, the first symbol of the consecutive symbols can be at least one of: a downlink (DL) symbol configured for an uplink (UL) subband (as shown in Slot 1 and Slot 2 of FIG. 2); a flexible (F) symbol configured for a UL subband; a symbol configured for a UL subband; a symbol configured for the subband full-duplex operation; a symbol valid for UL transmission in the UL subband; a UL symbol (as shown in Slot 4 of FIG. 2); or a F symbol. The different attributes of the symbols listed above can be used to transmit the PUCCH repetitions. For example, the PUCCH 1, PUCCH 2, and PUCCH 3′s first symbols is a DL symbol configured for an UL subband. The first symbols of PUCCH 4 of FIG. 2 is a UL symbol or (F symbol). The first symbol of PUCCH 1 of FIG. 4, and the first symbol of PUCCH 1 of FIG. 4 and FIG. 5 are UL or F symbols.

It should be noted that there may be additional symbol(s) preceding the first symbol of the plurality of consecutive symbols. For example, as shown in FIG. 2, there may be symbols 1-4 in front of symbol 5.

Additionally, the first symbol may be followed by one or more following symbols. The one or more following symbols may be: all DL symbols configured for the UL subband; all symbols configured for the subband full-duplex operation; all UL symbols; all valid symbols the PUCCH transmission; partially symbols of the UL subband and partially UL symbols; partially symbols for the UL subband and partially F symbols; or partially symbols for the UL subband, partially UL symbols, and partially F symbols.

The following symbols do not need to have the same attributes with each other, and the following symbols does not need to have the same attributes with the first symbols. As shown in PUCCH 3 in FIG. 2, the first part of the remaining symbols (and the first symbol) are DL symbols in the UL subband, and the second part of the remaining symbols, following the first part, are the UL symbols (or UL Bandwidth portion (BWP)). As another example, the first part of the remaining symbols (and the first symbol, symbol 5) of PUCCH 4 in FIG. 4 are DL symbols, and the rest of the remaining symbols following the first part of the remaining symbols are UL or F symbols.

This arrangement provide a flexible PUCCH repetitions scheme, and also this method allow the interference of the PUCCH repetitions to be reduced.

In S130, the UE can transmit the PUCCH repetitions in the one or more slots determined by the previous step.

According to one embodiment of this disclosure, determining one or more slots for the PUCCH transmission includes determining the one or more slots according to at least one of the following criteria, including: first criterion, where the one or more slots include the plurality of consecutive symbols starting from the first symbol, the plurality of consecutive symbols being DL symbols configured for the UL subband, the one or more slots include the first symbol same as the start symbol configured for the PUCCH resource, and the number of the consecutive symbols being equal to or larger than the number of symbols configured for the PUCCH resource; or second criterion, where the one or more slots include the plurality of consecutive symbols starting from the first symbol, the plurality of consecutive symbols being UL symbols or F symbols, the one or more slots include the first symbol same as the start symbol configured for the PUCCH resource, and the number of the consecutive symbols being equal to or larger than the number of symbols configured for the PUCCH resource; or third criterion, where the one or more slots include the plurality of consecutive symbols starting from the first symbol, the plurality of consecutive symbols being a combination of symbols selected from a group of symbols configured for the UL subband, UL symbols, or F symbols, and the one or more slots include the first symbol same as the start symbol configured for the PUCCH resource, and the number of the consecutive symbols being equal to or larger than the number of symbols configured for the PUCCH resource.

The UE or the BS can apply the above criteria to determine the proper slots of the PUCCH repetitions. The conditions in the above criteria can be isolated or combined with the conditions in another criterion.

According to the first criterion, the PUCCH repetitions can be transmitted in a UL subband of a DL slot of DL symbols; the UL subband includes a symbol identical to the start symbol configured for the PUCCH transmission. For example, UL subband may include a symbol have the same symbol numbering as to the numbering of the start symbol configured for the PUCCH transmission. The number of the consecutive symbols being equal to or larger than the number of symbols configured for the PUCCH transmission. With a sufficient length of the consecutive symbols following the symbols having the same start symbol of the PUCCH transmission, the UE can allocate the PUCCH repetitions in the slot meeting this requirement. The UE can use this criterion to search for the next slot that meets this criterion, and such slot can be determined as the next slot of the next PUCCH repetitions.

Using FIG. 2 as an example, according to criterion one, the UE may determine that slot 2 can be used to transmit the second PUCCH repetition, PUCCH 2. Slot 2 is a DL slot with DL symbols, and slot 2 is configured with a UL subband. Slot 2 here includes consecutive symbols symbol 5 to symbol 11. The number of the consecutive symbols (7) is equal to the number of the first symbols (symbol 5 to symbol 11 in UL subband of Slot 1) used to transmit the first PUCCH repetition, PUCCH1, and is equal to the number of symbols configured for the PUCCH transmission.

Additionally, Slot 2 in FIG. 2 includes symbol 5 that is identical to the start symbol 5 of the PUCCH 1 in Slot 1 with respect to the numbering (or location at the time domain). That is, the consecutive symbols in slot 2 includes the first symbol same as the start symbol configured for the PUCCH transmission. Therefore, Slot 2 is qualified to be used to transmit the PUCCH 2 according to the first criterion. It should be noted that Slot 2 may still be qualified under the first criterion if there is more symbols before symbol 5. The criterion requires a number of the consecutive symbols is larger than or equal to the number of symbols configured for the PUCCH transmission, so additional symbol(s) preceding symbol 5 does not disqualify Slot 2 to be used to transmit PUCCH 2. Similarly, additional symbols after symbol 11 does not disqualify Slot 2 from the first criterion.

Similarly, the UL subband in Slot 3 is qualified and can be used to transmit PUCCH 3 after PUCCH 2. However, Slot 3 is not qualified under criterion 1, but may be qualified under another criterion. In Slot 3, while it is configured with a UL subband, it's consecutive symbols after symbol 5 in the UL subband is not sufficient on its number. The BS or UE may use one, two, or all criteria 1 to 3 to select proper slot for PUCCH repetitions.

In the second criterion, the remaining PUCCH repetitions can be transmitted in an uplink (UL) or flexible (F) slot of UL or F symbols; the UL or F slot includes a symbol same as the start symbol configured for the PUCCH transmission with respect to the numbering (representing the sequence on the time domain); the number of the consecutive symbols being equal to or larger than the number of symbols configured for the PUCCH transmission, meaning that the consecutive symbols is lengthy enough to provide the PUCCH transmission.

For example, as shown in FIG. 2, Slot 4 is qualified to be used to transmit the remaining PUCCH repetitions under the second criterion. Slot 4 is a UL slot of UL symbols. Slot 4 includes symbol 5, which is identical to the start symbol of the first PUCCH repetition with respect to its numbering (representing the sequence of the symbols on the time domain). Additionally, the UL slot includes the number of the consecutive symbols in Slot 4 is equal to or larger than the number of symbols configured for the PUCCH transmission (which is 7, between symbol 5 and symbol 11). The UL slot includes the number of the consecutive symbols in Slot 4 is equal to or larger than the number of symbols of the first PUCCH repetition, PUCCH 1. Therefore, the UE and/or BS can determine that, under the second criterion, Slot 4 in FIG. 2 can be used to transmit the PUCCH.

According to the third criterion, the remaining PUCCH can be transmitted using any two of a UL subband in a DL slot of DL symbols, a UL slot of UL symbols, or a F slot of F symbols; the plurality of consecutive symbols include a first symbol same as the start symbol configured for the PUCCH transmission; and the number of the consecutive symbols being equal to or larger than the number of symbols configured for the PUCCH transmission. That is, the PUCCH can be transmitted with a combination of a UL subband in a DL slot of DL symbols, a UL slot of UL symbols, or a F slot of F symbols.

Under the third criterion, the remaining PUCCH can be transmitted using partially as DL symbol(s) in a UL subband and partially UL symbol(s) (as shown in PUCCH 3 of FIG. 2), using partially UL subband symbol(s) or partially F symbol(s) (as shown in PUCCH 4 of FIG. 4), or using partially UL symbol(s) and partially F symbols. The sequence of the combination is not limited. For example, the UL subband can preceding the UL symbol(s), or as an alternative the UL symbol(s) can precede the UL subband.

Using FIG. 2 as an example, Slot 3 is qualified to be used to transmit PUCCH repetitions under the third criterion. Slot 3 include a symbol same as the start symbol configured for the PUCCH transmission (that is, symbol 5 in the PUCCH 1) with respect to the numbering. Slot 3 includes the plurality of consecutive symbols, which are partially DL symbols in a UL subband and partially UL symbols. Additionally, the length of the consecutive symbols in Slot 3 is 7, equal to or larger than the number of symbols configured for the PUCCH transmission (and equal to or larger than the number of symbols of the first PUCCH repetition, PUCCH 1).

According to one embodiment, the UE and the BS can use one or more of the criteria as mentioned above. For example, the UE and BS can use two (or all) of the three criteria listed above. As an example, the UE and the BS can have a pre-set agreement on which criterion or criteria to use under certain conditions. Also, the BS may transmit a signaling to the UE to indicate which criterion or criteria should be used.

According to one embodiment, determining whether the DL symbols configured for the UL subband, the F symbols, or the UL symbols in the one or more slots are associated with a frequency resource and a frequency resource of the PUCCH resource is within the frequency resource. In a case (but not limited to) that the frequency resources allocated to different slots are different, the UE or the BS may further check whether the valid frequency resource given to the candidate slots in order to determine a proper slot that can be used to transmit the PUCCH repetitions.

According to one embodiment, the first PUCCH repetition of the N PUCCH repetitions is transmitted in a UL subband of a DL slot, or a UL bandwidth part (BWP) of a slot.

According to one embodiment, the method further comprises in the determined one or more slots, determining the same PUCCH resource as the indicated PUCCH resource for the PUCCH transmission.

According to one embodiment, in the determined one or more slots, the UE expects that the PUCCH resource is in both the frequency domain of the UL subband and the frequency domain of a UL BWP.

According to one embodiment, the UE expects that the UL subband and the UL BWP have the same frequency domain resources. Using Slot 3 of FIG. 3 as an example, the frequency resource assigned to the DL subband is wider than the UL BWP. Therefore, the PUCCH 3 as shown in Slot 3 may not have the associated valid frequency resource to transmit the second part of the PUCCH repetition. To prevent such condition (and the situation in Slot 3 and Slot 4 of FIG. 5), when determining the slot to transmit the PUCCH repetition, the UE and/or the BS may further check whether the DL symbol configured for an UL subband, the F symbol, or the UL symbol is associated with a valid frequency resource. If not, the DL symbol configured for an UL subband, the UL symbol or the F symbol cannot be used to transmit the PUCCH repetitions.

Accordingly, two solutions may be used to mitigate this issue. First of all, when a certain condition is met, the BS may have the frequency resource in different time slots to be the same. For example, the BS may have the frequency resource in different time slots to be the same in a case that the BS acknowledges that the PUCCH 1 will be transmitted or in a case that the BS acknowledges that N PUCCH repetition with be transmitted between the BS and the UE. Because the N repetitions usually transmit at the same frequency domain, once each of the slots of the frames has the same frequency resource as allocated, the N repetitions can be covered by the same assigned frequency resource in different slot.

According to another embodiment, the BS may configure the frequency resource of the slots according to the determination of the slots used to transmitted the PUCCH repetitions, such that the BS can configure the frequency resource to cover the symbols used to transmit the PUCCH repetition. In this method, once the BS and the UE have an agreement that N PUCCH repetitions will be transmitted, the BS can assign the frequency resource to specifically cover the symbols of the N PUCCH repetitions. In this case, the bandwidth of the different slots needs not to be the same.

According to one embodiment, the F symbols do not overlap with a synchronization signals/physical broadcast channel (SS/PBCH) block.

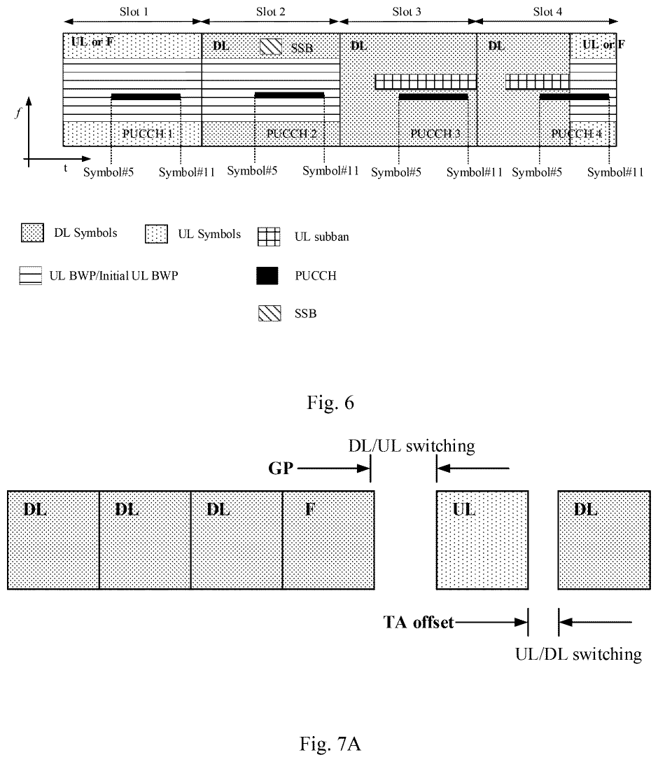

The UE and/or BS may further check if the Synchronization Signal/PBCH block is assigned to the same time domain of the candidate symbols. For example, as shown in Slot 2 of FIG. 6, the transmission of the SSB interferences the transmission of the PUCCH 2, so in this case, the PUCCH 2 should not be assigned to Slot 2.

According to another embodiment, in a case that the plurality of consecutive symbols are a combination of one or more DL symbols configured for the UL subband, and one or more UL symbols or one or more F symbols, the DL symbols and the UL symbols or the F symbols are continuous.

According to another embodiment, the BS or the UE may further check, in a case that the plurality of consecutive symbols are a combination of one or more DL symbols configured for the UL subband, and one or more UL symbols or one or more F symbols, the BS or the UE may further determine if the consecutive symbols are continuous.

According to one embodiment, in a case that the plurality of consecutive symbols are a combination of DL symbols configured for the UL subband, and UL symbols or F symbols, the DL symbols and the UL symbols or the F symbols are continuous in the time domain.

According to one embodiment, the DL symbols and the UL symbols or the F symbols are continuous in the time domain at least within the first frequency resource.

According to one embodiment, the first frequency is one of the frequency resource of the UL subband, the frequency resource of a UL BWP, or the smaller of the frequency resource of the UL subband and the frequency resource of the UL BWP.

According to another embodiment, in a case that the plurality of consecutive symbols are a combination of one or more DL symbols configured for the UL subband, and one or more UL symbols or one or more F symbols, a timing advance (TA) of the UL symbols or the F symbols is aligned with a TA of the UL subband.

According to another embodiment, the BS or the UE may further check, in a case that the plurality of consecutive symbols are a combination of one or more DL symbols configured for the UL subband, and one or more UL symbols or one or more F symbols, the BS or the UE may further determine a timing advance (TA) of the UL symbols or the F symbols is aligned with a TA of the UL subband

According to another embodiment, in a case that the plurality of consecutive symbols are a combination of one or more DL symbols configured for the UL subband, and one or more UL symbols or one or more F symbols, a TA offset between the symbols of the UL subband and the UL symbols or the F symbols is predefined or configured by the BS as 0.

According to another embodiment, the BS or the UE may further check, in a case that the plurality of consecutive symbols are a combination of one or more DL symbols configured for the UL subband, and one or more UL symbols or one or more F symbols, the BS or the UE may further determine a TA offset between the symbols of the UL subband and the UL symbols or the F symbols is predefined or configured by the BS as 0.

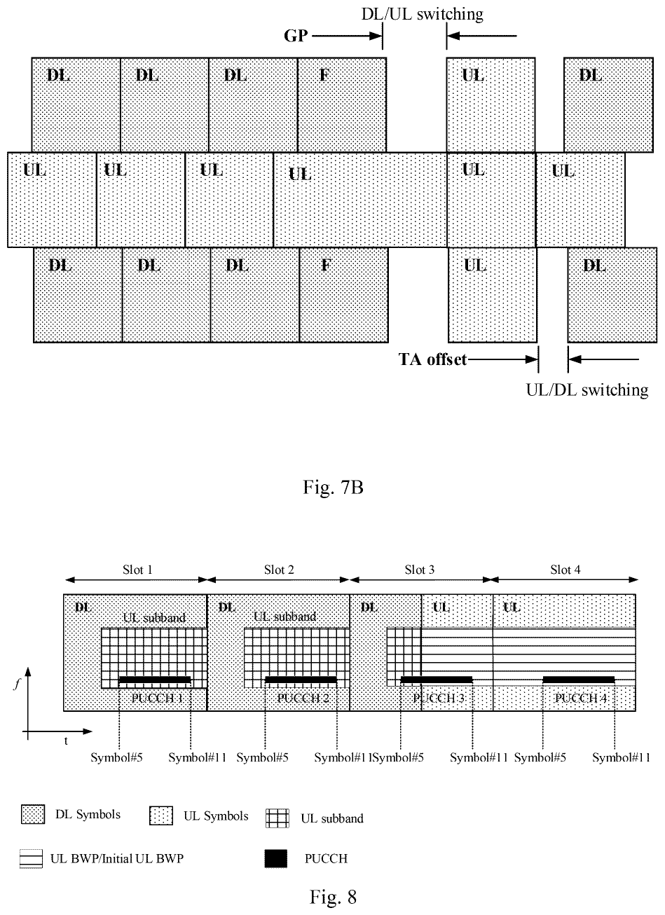

As shown in FIG. 7A, in the conventional wireless communication system, there may be a gap between the DL slot (or F slot used as a DL slot) and UL slot. Because the system needs some time to prepare the transition from the UL transmission to the DL transmission (or vice versa), a gap is implemented, in which the data cannot be transmitted. In such case, a time slot used to transmit the PUCCH repetition cannot overlap with the gap. Therefore, the UE or the BS may check if the DL symbols in the UL subband and the UL symbols or the F symbols are continuous when the BS or the UE determines the time slot used to transmit the PUCCH repetitions. In other words, in a case that the plurality of consecutive symbols are a combination of DL symbol(s) configured for an UL subband and UL/F symbol(s), the BS or the UE may further confirm a timing advance (TA) offset between the symbols of the UL subband and the UL symbols or the F symbols is predefined or configured by the BS as 0, or a TA of the UL symbol(s) or the F symbol(s) is aligned with a TA of the UL subband. FIG. 7B shows an example of TA that close the gap in the UL transmission.

This disclosure use exemplary embodiments to demonstrate the exemplary aspects of this invention.

For a PUCCH configured with PUCCH repetitions, the transmission of the first PUCCH repetition may have the following cases.

### Case 1:

Referring to FIG. 2, for UEs configured or instructed to transmit a PUCCH with N repetitions, if the UL subband is configured for UEs with UL subband capability, the first PUCCH repetition may be configured to transmit in the UL subband by using the configured or instructed PUCCH 1. A symbol configured for a UL subband may be a symbol configured for the subband full duplex operation. They are just described differently.

### Case 2:

Referring to FIG. 4, for UEs configured or instructed to transmit a PUCCH with N repetitions, if the UL subband is configured for UEs with UL subband capability, then the first PUCCH repetition may also be configured to transmit in the UL or flexible (F) symbols in the UL or F slot by using the configured or instructed PUCCH 1.

In the case 1 and case 2, the first PUCCH repetition, PUCCH1, may be configured to transmit in the UL subband, meaning that at least the start symbol of the PUCCH is in the UL subband.

In the case 1 and case 2, the UL subband may be configured to contain (at least) DL symbols. The configuration of DL symbols, UL symbols, and/or flexible (F) symbols may be determined based on a higher layer parameter tdd-UL-DL-ConfigurationCommon. Additionally, the UL BWP (bandwidth part as exemplarily shown in Slot 1 of FIG. 4) may be configured to contain UL symbols and/or F symbols.

In the frequency domain, there are three possible types of relationship between UL subbands and UL BWP:
In the first type, UL BWP that contains the UL subband;
In the second type, the UL subband is the same as the UL BWP; and
In the third type, the UL subband contains the UL BWP.

The first two types are typical scenarios.

For the above case 1 and case 2, the following methods can be used to determine slots and PUCCH resources for PUCCH repetition.

It is noted that, a symbol configured for a UL subband is a symbol configured for the subband full duplex operation, and this symbol is also called SBFD symbol. They are just described differently.

### Embodiment 1

For case 1, the following methods can be considered used to determine slots and PUCCH resources for PUCCH repetition.

### Method 1

A slot can be determined to transmit for the remaining PUCCH repetitions if the following conditions are met:
First, the slot is configured with the UL subband;
Second, a symbol in the UL subband that is the same as the start symbol of the PUCCH 1 can be provided, and
Third, starting from the symbol same as the start symbol of the PUCCH 1, consecutive symbols greater than or equal to the number of symbols of PUCCH 1 are all provided in the UL subband.

If a slot satisfies the above conditions, the slot may be used for the remaining PUCCH repetitions. In the determined slot(s), the same PUCCH resource as PUCCH 1 (where in this example, the same PUCCH resource is actually PUCCH 1 in determined slot) is used for the remaining PUCCH repetitions.

A specific example is provided in FIG. 2. Referring to FIG. 2, a PUCCH is configured to be repeated N times, and the first PUCCH repetition is configured or indicated in the first slot of FIG. 2.

According to the conditions of method 1, the slot 2 can be determined for the second PUCCH repetition. For example, the slot 2 can provide a UL subband. A symbol can be provided in the UL subband in slot 2, which is the same as the start symbol of the first PUCCH repetition. Also, starting from the first symbol, the number of consecutive symbols is equal to or greater than the number of symbols of the first PUCCH repetition; the consecutive symbols are all within the UL subband.

According to the conditions of method 1, the slot 3 in FIG. 2 cannot be determined for the third PUCCH repetition. For example, the slot 3 can provide an UL subband, and a symbol can be provided in the UL subband, which is the same as the start symbol of the first PUCCH repetition. Starting from the symbol, the number of consecutive symbols is equal to or greater than the number of symbols of the first PUCCH repetition, but the consecutive symbols are not all within the UL subband of Slot 3.

According to the conditions of method 1, the slot 4 in FIG. 2 cannot be determined for the third PUCCH repetition. For example, the Slot 4 cannot provide an UL subband, so it also cannot provide a symbol in the UL subband that is the same as the starting symbol of the first PUCCH repetition. Slot 4 also cannot provide consecutive greater than or equal to the number of symbols of the first PUCCH repetition in the UL subband.

In method 1, the PUCCH resources in the UL subband should come from the PUCCH resources configured in the UL BWP. That is, PUCCH resources are still configured per one UL BWP, and these configured PUCCH resources are also shared for the UL subband. In this way, the UL subband may be not actually independently configured with PUCCH resources. In method 1, the UL subbands may be independently configured with PUCCH resources.

The interference of UL transmission in method 1 in the UL subband may be different from the interference of UL transmission in the UL (or F) symbol, because the UL subband is arranged in the DL symbol, and the UL transmission may be susceptible to the interference of the DL transmission.

Although method 1 has greater restrictions on the choice of slot, it may ensure the consistency of interference faced by all PUCCH repetitions since they are all within the UL subband(s).

### Method 2

According to this approach, a slot can be determined to transmit for the remaining PUCCH repetitions if the following conditions are met:
First, the slot is configured with the UL (or F) symbols;
Second, a UL (or F) symbol that is the same as the start symbol of the PUCCH1 can be provided; and
Third, starting from this symbol, consecutive symbols greater than or equal to the number of symbols of PUCCH1 are all provided in the UL subband or are all UL (or F) symbols.

If a slot satisfies the above conditions, the slot may be used for the remaining PUCCH repetitions. In the determined slot, the same PUCCH resource as PUCCH 1 (where in this case the same PUCCH resource is actually PUCCH 1 in determined slot) is used for the remaining PUCCH repetitions.

This disclosure uses FIG. 2 to provide an exemplary example. Referring to FIG. 2, a PUCCH is configured to be repeated N times, and the first PUCCH repetition is configured or indicated in the first slot (Slot 1) of FIG. 2.

According to the conditions of method 2, the second slot (Slot 2) cannot be determined for the second PUCCH repetition. For example, the second slot cannot provide a UL symbol. According to the conditions of method 2, the third slot (Slot 3) cannot be determined for the second PUCCH repetition. For example, the third slot can provide an UL symbol at the later portion of the third slot, but the UL symbol is not the same as the start symbol of the first PUCCH repetition.

According to the conditions of method 2, the fourth slot (Slot 4) can be determined for the second PUCCH repetition. For example, the fourth slot can provide an UL symbol; the UL symbol is the same as the start symbol of the first PUCCH repetition; starting from the symbol, the number of consecutive symbols is equal to or greater than the number of symbols of the first PUCCH repetition; finally, the consecutive symbols are all the UL symbols.

In method 2, the PUCCH resources in the UL subband may come from the PUCCH resources configured in the UL BWP. That is, PUCCH resources may be still configured per UL BWP, and these configured PUCCH resources are also shared for the UL subband. In this way, the UL subband may be not actually independently configured with PUCCH resources. In method 2, the UL subbands may be independently configured with PUCCH resources.

### Method 3

According to the third approach, a slot can be determined to transmit for the remaining PUCCH repetitions if the following conditions are met:
First, the slot is configured with the UL subband and UL (or F) symbol;
Second, a symbol in the UL subband that is the same as the start symbol of the PUCCH 1 can be provided; and
Third, starting from this symbol, consecutive symbols greater than or equal to the number of symbols of PUCCH1 are the symbols of the UL subband and UL (or F) symbols.

If a slot satisfies the above conditions, the slot can be used for the remaining PUCCH repetitions. In the determined slot, the same PUCCH resource as PUCCH 1 (where in this case the same PUCCH resource is actually PUCCH 1 in determined slot) is used for the remaining PUCCH repetitions.

An optional supplementary condition A can be provided. For the case that the consecutive symbols are the symbols of the UL subband and the UL (or F) symbols, an additional condition can be introduced to ensure that PUCCH 1 in the consecutive symbols is valid.

For example, a timing advance (TA) of the UL (or F) symbol or UL BWP (e.g., when the UL BWP are configured in the UL/F symbol) and the TA of the UL subband (or the symbols of the UL subband) are aligned; in other words, a TA offset between the symbols of the UL subband and the UL (or F) symbols is predefined as 0 or configured as 0 by the base station (BS); in still other words, the symbols of the UL subband and the UL (or F) symbols are continuous in the time domain.

In the case where the above condition is not satisfied, the PUCCH 1 in the consecutive symbols is invalid because there may be a gap between the consecutive symbols. In this case, although a slot satisfies many of the above conditions in the methods described above, since PUCCH 1 in the consecutive symbol is not valid, the slot cannot be used for the remaining PUCCH repetitions.

Referring to FIG. 2, a PUCCH is configured to be repeated N times, and the first PUCCH repetition is configured or indicated in the first slot (Slot 1) of FIG. 2.

According to the conditions of method 3, the second slot (Slot 2) cannot be determined for the second PUCCH repetition. For example, the second slot cannot provide a UL subband and a UL (or F) symbol at the same time.

According to the conditions of the third method, the third slot (Slot) can be determined for the second PUCCH repetition. For example, the third slot can provide an UL subband and UL symbol; a symbol can be provided in the UL subband, which is the same as the start symbol of the first PUCCH repetition; starting from the symbol, the number of consecutive symbols in the UL subband and UL symbols (symbol 5 to symbol 11) is equal to or greater than the number of symbols of the first PUCCH repetition; that is, the consecutive symbols are the symbols of the UL subband and the UL symbols. It should be noted that the condition A can be implemented but to simplify the explanation, this disclosure presumes the condition A is satisfied.

According to the conditions of method 3, the fourth slot (Slot 4) cannot be determined for the third PUCCH repetition. For example, the fourth slot cannot provide a UL subband and a UL (or F) symbol at the same time.

In method 3, the PUCCH resources in the UL subband may come from the PUCCH resources configured in the UL BWP. That is, PUCCH resources are still configured per one UL BWP, and these configured PUCCH resources are also shared for the UL subband. In this way, the UL subband is not actually independently configured with PUCCH resources. In method 3, the UL subbands may be independently configured with PUCCH resources.

### Method 4

According to the fourth method, a slot can be determined to transmit for the remaining PUCCH repetitions if any one of the following conditions are met:
First, the slot can be determined by any one of method 1, method 2 and method 3, or
Second, the slot can be determined by any two of the method 1, method 2, and method 3. The two methods can be pre-agreed by the base station and the UE, or the two methods can be configured by the base station through signaling.

If a slot satisfies the above conditions, the slot may be used for the remaining PUCCH repetitions. In the determined slot, the same PUCCH resource as PUCCH 1 (here the same PUCCH resource is actually PUCCH 1 in determined slot) is used for the remaining PUCCH repetitions.

### Method 5

According to method 5, the BS can provide a signaling to the UE to indicate which methods 1 to 3 or their combination can be used to determine the slot to transmit the PUCCH.

For example, through signaling, the base station may indicate that the conditions for determining the slot are the same as method 1, method 2, method 3, or method 4.

As another example, through signaling, the base station may indicate which two methods are used to determine the slot from method 1, method 2 and method 3. If a slot satisfies any one of the two indicated methods, the slot can be determined for the PUCCH repetitions.

As still another example, through signaling, the base station may indicate that method 1, method 2 and method 3 are used to determine the slot. If a slot satisfies any one of the three indicated methods, the slot may be determined for the PUCCH repetitions.

If the slot satisfies the above conditions, the slot is used for the remaining PUCCH repetitions. In the determined slot, the same PUCCH resource as PUCCH 1 (where in the intents example the same PUCCH resource is actually PUCCH 1 in determined slot) is used for the remaining PUCCH repetitions.

Briefly speaking of the method 1 to 5 above, if a PUCCH is configured or instructed to perform N times of PUCCH repetitions (N being integer larger than 1), then the BS and UE shall determine the slot and PUCCH resources for receiving and sending the PUCCH repetitions according to the following conditions, respectively:
A slot can provide a symbol that is used for UL transmission in the UL subband, or a DL symbol that is configured for the UL subband, or a symbol that is located in the UL subband, or a UL (or F) symbol, as the first symbol; and the first symbol is the same as the configured start symbol of the PUCCH (e.g., having the same symbol index in a slot); and
the slot can provide consecutive symbols from the first symbol, and the number of consecutive symbols is greater than or equal to the number of configured symbols of the PUCCH, wherein the consecutive symbols are from:
   a set of symbols consisting of symbols of the UL subband in the slot, or
   a set of symbols consisting of UL (or F) symbols in the slot, or
   a set of symbols consisting of the symbols of the UL subband in the slot and the

UL (or F) symbols in the slot.

Additionally, the F symbol here does not overlap the SSB in the time domain.

### Method 6

Referring to FIG. 3, the first PUCCH repetition of a PUCCH may be configured in the first slot in the UL subband. If the slot and PUCCH resource for the remaining PUCCH repetition are determined according to the above methods 1 to 3 above, the following problem will occur:

The second slot (Slot 2) can be determined for the second PUCCH repetition according to method 1 above. The third slot can be determined for the third PUCCH repetition according to method 3 above. The fourth slot can be determined for the fourth PUCCH repetition according to method 2 above.

However, since the UL subband contains the UL BWP in the frequency domain (meaning that the UL subband is wider than the UL BWP in the frequency domain of Slot 3 in FIG. 3), in the determined third slot and the fourth slot, the determined PUCCH resource that is the same as the PUCCH is invalid. Because the determined PUCCH resource exceeds the range of the UL BWP in the frequency domain. The following provides some improvements for the above methods 1˜3.

For a determined slot and PUCCH resource according to the above methods 1˜3, if the determined PUCCH resource is valid in the determined slot, then the determined slot is finally determined for the PUCCH repetitions; otherwise, the determined slot cannot be finally determined for the PUCCH repetitions. Here, the valid PUCCH resource refers to that the PUCCH resource is within the UL BWP or within the UL subband in the frequency domain.

Thus, referencing to FIG. 3, the slot and PUCCH resource for the remaining PUCCH repetition are determined according to the combination of methods 1˜3 above with the following additional conditions:

The second slot (Slot 2) can be determined as the second PUCCH repetition according to method 1 above. Here, the added condition can actually be absent.

The third slot (Slot 3), however, cannot be determined to be used for the third PUCCH repetition according to the combination of method 3 above and the additional conditions, which check if there is a valid frequency resource in Slot 3 as the frequency resource of the PUCCH 2 in Slot 2. Because in the third slot, the determined PUCCH resource is not valid (as the second part of the PUCCH 3 is not covered by the frequency resource of the UL BWP in Slot 3), and the PUCCH resource exceeds the frequency domain range of UL BWP in some symbols. Here, the additional condition can be used to ensure the PUCCH is assigned a proper slot.

Likewise, the fourth slot (slot 3) cannot be determined as the third PUCCH repetition according to the combination of the above method 2 and the additional conditions. Because in the fourth slot, the determined PUCCH resource is not valid, and the PUCCH resource exceeds the frequency domain range of the UL BWP. Here, the added condition is necessary.

### Embodiment 2

For case 2 (as describe above with a reference to FIG. 4), the following methods can be considered to determine a proper slot or PUCCH resource for PUCCH repetitions.

### Method 7

According to method 7, a slot can be determined to transmit for the remaining PUCCH repetitions if the following conditions are met:
The slot is configured with a UL (or F) symbol; and
A UL (or F) symbol that is the same as the start symbol of the PUCCH1 can be provided; and
Starting from the UL (or F) symbol, consecutive symbols greater than or equal to the number of symbols of PUCCH 1 are all UL (or F) symbols.

If a slot satisfies the above conditions, the slot may be used for the remaining PUCCH repetitions. In the determined slot, the same PUCCH resource as PUCCH1 (where the same PUCCH resource is actually PUCCH 1 in determined slot) is used for the remaining PUCCH repetitions.

Referring to FIG. 4, a PUCCH is configured to be repeated N times, and the first PUCCH repetition is configured or indicated in the first slot of FIG. 4.

According to the conditions of method 7, the second slot (Slot 2) cannot be determined for the second PUCCH repetition. For example, the second slot cannot provide a UL symbol. According to the conditions of method 7, the third slot cannot be determined for the second PUCCH repetition either. For example, the third slot (Slot 3) cannot provide a UL symbol.

According to the conditions of method 7, the fourth slot (Slot 4) cannot be determined for the second PUCCH repetition. For example, the fourth slot can provide a UL symbol, but the UL symbol is different from the start symbol of the first PUCCH repetition.

In method 7, the PUCCH resources in the UL subband may come from the PUCCH resources configured in the UL BWP. That is, PUCCH resources are still configured per one UL BWP, and these configured PUCCH resources are also shared for the UL subband. In this way, the UL subband is not actually independently configured with PUCCH resources. In method 7, the UL subbands may be independently configured with PUCCH resources.

### Method 8

According to method 8, a slot can be determined to transmit for the remaining PUCCH repetitions if the following conditions are met:
A slot is configured with the UL subband or UL (or F) symbols; and
A symbol in the UL subband that is the same as the start symbol of the PUCCH 1 can be provided, or a UL (or F) symbol that is the same as the start symbol of the PUCCH 1 can be provided and
Starting from this symbol, consecutive symbols greater than or equal to the number of symbols of PUCCH1 are all provided in the UL subband or are all UL symbols (or F symbols).

If a slot satisfies the above conditions, the slot may be used for the remaining PUCCH repetitions. In the determined slot, the same PUCCH resource as PUCCH1 (where the same PUCCH resource is actually PUCCH 1 in determined slot here) is used for the remaining PUCCH repetitions.

Referring to FIG. 4, one PUCCH repetition is configured to be repeated N times, and the first PUCCH repetition is configured or indicated in the first slot of FIG. 4. According to the conditions of method 8, the second slot (Slot 2) can be determined for the second PUCCH repetition. For example, the second slot can provide a UL subband. And a symbol can be provided in the UL subband, which is the same as the start symbol of the first PUCCH repetition. And starting from the symbol, the number of consecutive symbols is equal to or greater than the number of symbols of the first PUCCH repetition, and all of the consecutive symbols are within the UL subband.

According to the conditions of method 8, the third slot (Slot 3) can be determined for the third PUCCH repetition. For example, the third slot can provide a UL subband; a symbol can be provided in the UL subband, which is the same as the start symbol of the first PUCCH repetition; starting from the symbol, the number of consecutive symbols is equal to or greater than the number of symbols of the first PUCCH repetition, and all of the consecutive symbols are within the UL subband.

According to the conditions of method 8, the fourth slot (Slot 4) cannot be determined for the fourth PUCCH repetition. For example, the fourth slot can provide a UL subband; a symbol can be provided in the UL subband, which is the same as the start symbol of the first PUCCH repetition; starting from the symbol, the number of consecutive symbols is equal to or greater than the number of symbols of the first PUCCH repetition, but the consecutive symbols are not all the UL (or F) symbols or are not all in the UL subband. In method 8, the PUCCH resources in the UL subband should come from the PUCCH resources configured in the UL BWP. That is, PUCCH resources are still configured per one UL BWP, and these configured PUCCH resources are also shared for the UL subband. In this way, the UL subband is not actually independently configured with PUCCH resources. In method 8, the UL subbands may be independently configured with PUCCH resources.

### Method 9

According to method 9, a slot can be determined to transmit for the remaining PUCCH repetitions if the following conditions are met:
The slot is configured with the UL subband and UL (or F) symbol; and
A symbol in the UL subband that is the same as the start symbol of the PUCCH 1 can be provided; and
Starting from this symbol, consecutive symbols greater than or equal to the number of symbols of PUCCH 1 are the symbols of the UL subband and UL (or F) symbols.

If a slot satisfies the above conditions, the slot may be used for the remaining PUCCH repetitions. In the determined slot, the same PUCCH resource as PUCCH 1 (where the same PUCCH resource is actually PUCCH 1 in determined slot here) is used for the remaining PUCCH repetitions.

For the case that the consecutive symbols are the symbols of the UL subband and the UL (or F) symbols, an additional condition A can be introduced to ensure that PUCCH 1 in the consecutive symbols is valid. For example, a timing advance (TA) of the UL (or F) symbol or UL BWP (e.g., the UL BWP are configured in the UL/F symbol) and the TA of the UL subband (or the symbols of the UL subband) are aligned; in other words, a TA offset between the symbols of the UL subband and the UL (or F) symbols is predefined as 0 or configured as 0 by the base station; in still other words, the symbols of the UL subband and the UL (or F) symbols are continuous in the time domain.

In the case where the condition A is not satisfied, the PUCCH 1 in the consecutive symbols is invalid. Then, although a slot satisfies many of the above conditions in the methods above, since PUCCH 1 in the consecutive symbol is not valid (i.e., condition A is not satisfied because there is a gap between a DL slot and a UL slot and a DL slot), the slot cannot be used for the remaining PUCCH repetitions.

Referring to FIG. 4, one PUCCH repetition is configured to be repeated N times, and the first PUCCH repetition is configured or indicated in the first slot (Slot 1) of FIG. 4.

According to the conditions of method 9, the second slot (Slot 2) cannot be determined for the second PUCCH repetition. For example, the second slot cannot provide a UL subband and a UL (or F) symbol at the same time.

According to the conditions of method 9, the third slot (Slot 3) cannot be determined for the second PUCCH repetition. For example, the third slot (Slot 3) cannot provide a UL subband and a UL (or F) symbol at the same time.

According to the conditions of method 9, the fourth slot (Slot 4) can be determined for the second PUCCH repetition. For example, the fourth slot can provide an UL subband and UL symbol; a symbol can be provided in the UL subband, which is the same as the start symbol of the first PUCCH repetition; starting from the symbol, the number of consecutive symbols in the UL subband and UL symbols is equal to or greater than the number of symbols of the first PUCCH repetition; that is, the consecutive symbols are the symbols of the UL subband and the UL symbols.

### Method 10

According to method 10, a slot can be determined to transmit for the remaining PUCCH repetitions if the following conditions are met:
The slot can be determined by any one of method 7, method 8 and method 9; or
The slot can be determined by any two of the methods 7 to 9. The two methods can be pre-agreed by the base station and the UE, or alternatively the two methods can be configured by the base station through signaling.

If a slot satisfies the above conditions, the slot may be used for the remaining PUCCH repetitions. In the determined slot, the same PUCCH resource as PUCCH 1 (where the same PUCCH resource is actually PUCCH 1 in determined slot here) is used for the remaining PUCCH repetitions.

### Method 11

According to method 11, the conditions for determining the slot are configured by the base station through signaling. For example, through signaling, the base station indicates that the conditions for determining the slot are the same as method 7, method 8, method 9, or method 10. As another example, through signaling, the base station indicates which two methods are used to determine the slot from method 7, method 8 and method 9. If a slot satisfies any one of the two indicated methods, the slot is determined for the PUCCH repetitions. For example, through signaling, the base station indicates that method 7, method 8, and method 9 are used to determine the slot. If a slot satisfies any one of the three indicated methods, the slot is determined for the PUCCH repetitions.

If a slot satisfies the above conditions, the slot may be used for the remaining PUCCH repetitions. In the determined slot, the same PUCCH resource as PUCCH 1 (here the same PUCCH resource is actually PUCCH 1 in determined slot) is used for the remaining PUCCH repetitions.

Briefly speaking of Method 7˜11, if a PUCCH is configured or instructed to perform N times of PUCCH repetitions, then the base station and UE shall determine the slot and PUCCH resources for receiving and sending the PUCCH repetitions according to the following conditions, respectively:
A slot can provide a symbol that is used for UL transmission in the UL subband, or a DL symbol that is configured for the UL subband, or a symbol that is located in the UL subband, or a UL (or F) symbol, as the first symbol, the first symbol being the same as the configured start symbol of the PUCCH (e.g., having the same symbol index in a slot); and
The slot can provide consecutive symbols from the first symbol, and the number of consecutive symbols is greater than or equal to the number of configured symbols of the PUCCH, the consecutive symbols being from:
   a set of symbols consisting of symbols of the UL subband in the slot, or
   a set of symbols consisting of UL (or F) symbols in the slot, or
   a set of symbols consisting of the symbols of the UL subband in the slot and the UL (or F) symbols in the slot.

The F symbol here does not overlap the SSB in the time domain.

### Method 12 (Similar to Method 6 Above)

Referring to FIG. 5, the first PUCCH repetition of a PUCCH is configured in the first slot in the UL symbols. If the slot and PUCCH resource for the remaining PUCCH repetition are determined according to the above methods 7˜9, the following problem may occur.

For example, the second slot (Slot 2) can be determined for the second PUCCH repetition according to method 7 above. The third slot (Slot 3) can be determined for the third PUCCH repetition according to method 8 above. The fourth slot (Slot 4) can be determined for the fourth PUCCH repetition according to method 9 above.

However, since the UL BWP contains the UL subband in the frequency domain (meaning that the frequency resource of the UL BWP in Slot 1 and Slot 2 are wider that the frequency domain of the UL subband in Slot 3 and Slot 4), in the determined third slot and the fourth slot, the determined PUCCH resource that is the same as the PUCCH is invalid (not covered by the assigned frequency resource of the UL subband). Because the determined PUCCH resource exceeds the range of the frequency resource of the UL subband in the frequency domain. The following provides some improvements for the above methods 7˜9.

For a determined slot and PUCCH resource according to the above methods 7˜9, if the determined PUCCH resource is valid in the determined slot, then the determined slot is finally determined for the PUCCH repetitions; otherwise, the determined slot cannot be finally determined for the PUCCH repetitions. That is, the BS or the UE may further determine whether a slot is assigned valid frequency resource corresponding to the frequency band of the PUCCH repetitions. Here, the valid PUCCH resource refers to that the PUCCH resource is within the UL BWP or within the UL subband in the frequency domain.

Thus, with reference to FIG. 5, the slot and PUCCH resource for the remaining PUCCH repetition are determined according to the combination of methods 7˜9 above and the additional condition for the check of the frequency resource: Here, the second slot can be determined as the second PUCCH repetition according to method 7 above. The third slot cannot be determined as the third PUCCH repetition according to the combination of method 8 above and the additional conditions. In the third slot, the determined PUCCH resource is not valid, and the PUCCH resource exceeds the frequency domain range of UL subband.

The fourth slot in FIG. 5 cannot be determined as the third PUCCH repetition according to the combination of the above method 9 and the additional conditions. In the fourth slot, the determined PUCCH resource is not valid, and the PUCCH resource exceeds the frequency domain range of the UL subband in some symbols.

### Embodiment 3

According to Embodiment 3, some restrictions related to UL subbands or PUCCH resources are introduced as PUCCH repetitions, so that it is simpler to determine the slot and PUCCH resources for the PUCCH repetitions.

According to one implementation, the BS and the UE agree that if a PUCCH is instructed or configured to perform N (an integer greater than 1) PUCCH repetitions based on the UL subband, the BS should configure the PUCCH resource of the PUCCH repetition in the frequency domain within the UL subband or the UL BWP. That is, the BS may configure the PUCCH repetitions to use the valid frequency resource.

For example, if the PUCCH repetitions are allowed to be transmitted in the UL subband and the UL BWP, the BS can configure the PUCCH resource of the PUCCH repetition to be in the frequency domain in the UL subband. That is, the methods in method 6 and method 12 are indirectly implemented by configuring the PUCCH in the UL subband by the base station. That is, under this restriction, if the slots and PUCCH resource for PUCCH repetitions are determined based on methods 1-5 or methods 7-11, the determined PUCCH resource is always valid in the UL subband of the determined slot.

The UE expects the PUCCH resource of the PUCCH repetition to be within the frequency domain of the UL subband. For example, if the PUCCH repetitions are allowed to be transmitted in the UL subband and the UL BWP, the UE expects the PUCCH resource of the PUCCH repetition to be within the frequency domain of the UL subband. The UE can determine the slot with UL subband and PUCCH resource for PUCCH repetition based on methods 1 to 5 or methods 7 to 11, and the PUCCH resource determined by the UE is always valid. The UE does not need to implement the judgment conditions in methods 6 or 12.

Alternatively, according to one implementation, the BS and the UE agree that if a PUCCH is instructed or configured to perform N (an integer greater than 1) PUCCH repetitions based on the UL subband, the base station always keeps the UL subband and the UL BWP the same (with respect to size and/or location) through the configuration in the frequency domain. For example, if the PUCCH repetitions are allowed to be transmitted in the UL subband and the UL BWP, the base station may configure that the frequency domain resources of the UL subband and the UL BWP with the same size and/or location as shown in FIG. 8. Under this restriction, if the slots and PUCCH resources for PUCCH repetitions are determined based on methods 1-5 or 7-11, the determined PUCCH resources are always valid in the UL subband of the determined slots. Because the size and location of the UL subband and the UL BWP in the frequency domain are the same, the PUCCH in the UL BWP and the UL subband are both valid in the frequency domain. The UE expects that the frequency domain resources of the UL subband and the UL BWP are the same (with respect to the size and location).

For example, if the PUCCH repetitions are allowed to be transmitted in the UL subband and the UL BWP, the UE expects that the frequency domain resources of the UL subband and the UL BWP are the same (with respect to the size and location). Under this restriction, if the slots and PUCCH resources for PUCCH repetitions are determined based on methods 1-5 or 7-11, the determined PUCCH resources are always valid in the UL subband of the determined slot. Because the size and location of the UL subband and the UL BWP in the frequency domain are the same, the PUCCH in the UL BWP and the UL subband are both valid in the frequency domain.

The methods/steps disclosed above can be performed by the UE, the BS, and the wireless communication device as disclosed in FIG. 1. Additionally, the hardware of the UE, the BS, and the wireless communication system may include non-transitory computer readable storage medium, storing one or more instructions. When the one or more instruction is executed by a processor, a wireless communication device is caused to perform the methods/steps as disclosed above.

Various exemplary embodiments of the present disclosure are described below with reference to the accompanying figures to enable a person of ordinary skill in the art to make and use the present disclosure. The present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art would understand that the methods and techniques disclosed herein present various steps or acts in exemplary order(s), and the present disclosure is not limited to the specific order or hierarchy presented unless expressly stated otherwise.

This disclosure is intended to cover any conceivable variations, uses, combination, or adaptive changes of this disclosure following the general principles of this disclosure, and includes well-known knowledge and conventional technical means in the art and undisclosed in this application.

It is to be understood that this disclosure is not limited to the precise structures or operation described above and shown in the accompanying drawings, and various modifications and changes may be made without departing from the scope of this application. The scope of this application is subject only to the appended claims.

1. A wireless communication method, comprising:
receiving a signaling, from a base station (BS), to indicate a user equipment (UE) to perform a PUCCH transmission with N PUCCH repetitions using a PUCCH resource, N being an integer larger than 1;
determining one or more slots for the PUCCH transmission, wherein the one or more slots include a plurality of consecutive symbols, a number of the consecutive symbols being equal to or larger than a number of symbols configured for the PUCCH resource, wherein the plurality of consecutive symbols include a first symbol being the same as a start symbol configured for the PUCCH resource, wherein the first symbol is at least one of:
a downlink (DL) symbol configured for an uplink (UL) subband;
a flexible (F) symbol configured for a UL subband;
a symbol configured for a UL subband;
a symbol configured for a subband full-duplex operation;
a symbol valid for UL transmission in the UL subband;
a UL symbol; or
a F symbol, wherein the consecutive symbols starting from the first symbol, the consecutive symbols being:
all DL symbols configured for the UL subband;
all symbols configured for the subband full-duplex operation;
all UL symbols;
all valid symbols the PUCCH resource;
partially symbols of the UL subband and partially UL symbols;
partially symbols for the UL subband and partially F symbols; or
partially symbols for the UL subband, partially UL symbols, and partially F symbols; and
transmitting the PUCCH repetitions in the one or more slots.

2. The method of claim 1, wherein determining one or more slots for the PUCCH transmission comprises determining the one or more slots according to at least one of the following criteria, comprising:
first criterion, where the one or more slots include the plurality of consecutive symbols starting from the first symbol, the plurality of consecutive symbols being DL symbols configured for the UL subband, the one or more slots include the first symbol same as the start symbol configured for the PUCCH resource, and the number of the consecutive symbols being equal to or larger than the number of symbols configured for the PUCCH resource; or
second criterion, where the one or more slots include the plurality of consecutive symbols starting from the first symbol, the plurality of consecutive symbols being UL symbols or F symbols, the one or more slots include the first symbol same as the start symbol configured for the PUCCH resource, and the number of the consecutive symbols being equal to or larger than the number of symbols configured for the PUCCH resource; or
third criterion, where the one or more slots include the plurality of consecutive symbols starting from the first symbol, the plurality of consecutive symbols being a combination of symbols selected from a group of symbols configured for the UL subband, UL symbols, or F symbols, and the one or more slots include the first symbol same as the start symbol configured for the PUCCH resource, and the number of the consecutive symbols being equal to or larger than the number of symbols configured for the PUCCH resource.

3. The method of claim 2, wherein all of the one or more slots meet either one of the first to third criteria.

4. The method of claim 2, wherein the one or more slots meet two different criteria among the first to third criteria.

5. The method of claim 4, wherein the two different criteria are determined by a pre-set agreement between the UE and the BS; or
the two different criteria are determined according to a signaling from the BS to the UE to designate the two different criteria.

6. The method of claim 2, further comprising receiving a signaling from the BS to determine which criterion or criteria are used to determine the one or more slots.

7. (canceled)

8. The method of claim 1, wherein determining one or more slots for the PUCCH transmission further comprises:
determining whether the DL symbols configured for the UL subband, the F symbols, or the UL symbols in the one or more slots are associated with a frequency resource and a frequency resource of the PUCCH resource is within the frequency resource.

9. The method of claim 1, wherein a first PUCCH repetition of the N PUCCH repetitions is transmitted in a UL subband of a DL slot, or a UL bandwidth part (BWP) of a slot.

10. The method of claim 1, further comprising: in the determined one or more slots, determining the same PUCCH resource as the indicated PUCCH resource for the PUCCH transmission.

11. (canceled)

12. (canceled)

13. (canceled)

14. (canceled)

15. (canceled)

16. (canceled)

17. (canceled)

18. A wireless communication method, comprising:
transmitting a signaling, from a base station (BS), to indicate a user equipment (UE) to perform a PUCCH transmission with N PUCCH repetitions using a PUCCH resource, N being an integer larger than 1;
determining one or more slots for the PUCCH transmission, wherein the one or more slots include a plurality of consecutive symbols, a number of the consecutive symbols being equal to or larger than a number of symbols configured for the PUCCH resource, wherein the consecutive symbols include a first symbol being the same as a start symbol configured for the PUCCH transmission, wherein the first symbol is at least one of:
a downlink (DL) symbol configured for an uplink (UL) subband;
a flexible (F) symbol configured for a UL subband;
a symbol configured for a UL subband;
a symbol configured for a subband full-duplex operation;
a symbol valid for UL transmission in the UL subband;
a UL symbol; or
a F symbol; wherein the consecutive symbols starting from the first symbol, the consecutive symbols being:
all DL symbols configured for the UL subband;
all symbols configured for the subband full-duplex operation;
all UL symbols;
all valid symbols the PUCCH resource;
partially symbols of the UL subband and partially UL symbols;
partially symbols for the UL subband and partially F symbols; or
partially symbols for the UL subband, partially UL symbols, and partially F symbols; and
receiving the PUCCH repetitions in the one or more slots.

19. The method of claim 18, wherein determining one or more slots for the PUCCH transmission comprises determining the one or more slots according to at least one of the following criteria, comprising:
first criterion, where the one or more slots include the plurality of consecutive symbols starting from the first symbol, the plurality of consecutive symbols being DL symbols configured for the UL subband, the one or more slots include the first symbol same as the start symbol configured for the PUCCH resource, and the number of the consecutive symbols being equal to or larger than the number of symbols configured for the PUCCH resource; or
second criterion, where the one or more slots include the plurality of consecutive symbols starting from the first symbol, the plurality of consecutive symbols being UL symbols or F symbols, the one or more slots include the first symbol same as the start symbol configured for the PUCCH resource, and the number of the consecutive symbols being equal to or larger than the number of symbols configured for the PUCCH resource; or
third criterion, where the one or more slots include the plurality of consecutive symbols starting from the first symbol, the plurality of consecutive symbols being a combination of symbols selected from a group of symbols configured for the UL subband, UL symbols, or F symbols, and the one or more slots include the first symbol same as the start symbol configured for the PUCCH resource, and the number of the consecutive symbols being equal to or larger than the number of symbols configured for the PUCCH resource.

20. The method of claim 19, wherein all of the one or more slots meet either one of the first to third criteria.

21. The method of claim 19, wherein the one or more slots meet two different criteria among the first to third criteria.

22. The method of claim 21, wherein the two different criteria are determined by a pre-set agreement between the UE and the BS; or
the two different criteria are determined according to a signaling from the BS to the UE to designate the two different criteria.

23. The method of claim 19, further comprising transmitting a signaling from the BS indicating which criterion or criteria are used to determine the one or more slots.

24. (canceled)

25. The method of claim 18, wherein determining one or more slots for the PUCCH transmission further comprises:
determining whether the DL symbols configured for the UL subband, the F symbols, or the UL symbols in the one or more slots are associated with a frequency resource and a frequency resource of the PUCCH resource is within the frequency resource.

26. The method of claim 18, wherein a first PUCCH repetition of the N PUCCH repetitions is transmitted in a UL subband of a DL slot, or a UL bandwidth part (BWP) of a slot.

27. The method of claim 18, further comprising: in the determined one or more slots, determining the same PUCCH resource as the indicated PUCCH resource for the PUCCH transmission.

28. (canceled)

29. (canceled)

30. (canceled)

31. (canceled)

32. (canceled)

33. (canceled)

34. (canceled)

35. (canceled)

36. (canceled)

37. A wireless communication apparatus, comprising a memory storing one or more programs and a processor electrically coupled to the memory and configured to execute the one or more programs to perform the method of claim 1.

38. (canceled)

39. A wireless communication apparatus, comprising a memory storing one or more programs and a processor electrically coupled to the memory and configured to execute the one or more programs to perform the method of claim 18.
